(19) United States
(12) Patent Application Publication
(10) Pub. No.: US 2009/0301116 A1
(43) Pub. Date: Dec. 10, 2009

(54) CLIMATE CONTROLLING SYSTEM

(75) Inventors: John F. Nathan, Highland Twp., MI (US); Karl Kennedy, Fraser, MI (US); Santosh Karumathil, Thane, MH (IN)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 12/135,757

(22) Filed: Jun. 9, 2008

(51) Int. Cl. F25B 49/00

(52) U.S. Cl. 62/208

(57) ABSTRACT

A climate controlling system including an HVAC system and a climate modification subsystem. The HVAC system adds conditioned air into a passenger compartment of an electric vehicle. The HVAC system transmits a signal indicative of its power consumption state. The climate modification subsystem is configured to alter the perceived temperature of a vehicle occupant. The climate modification subsystem transmits a signal indicative of its power consumption state. A controller is connected to the HVAC system and to the subsystem. The controller monitors the signals transmitted by the HVAC system and the subsystem. The controller apportions power between the HVAC system and the subsystem to achieve a minimum combined power consumption state while maintaining a predetermined occupant perceived temperature.

### BACKGROUND OF THE INVENTION

1. Field of the Invention

Embodiments of the present invention relate to climate control systems in electric vehicles and hybrid electric vehicles that have a plurality of systems and sub-systems, each of which is capable of causing a change in an occupant's perceived temperature. The power consumption level of the different systems are controlled by a controller that is capable of apportioning power between and among the different systems and sub-systems to achieve a desired perceived temperature while minimizing the combined total power consumed by the systems.

2. Background Art

Hybrid electric vehicles, dual mode hybrid electric vehicles and electric vehicles have a maximum range that is impacted by the power consumption of onboard systems in the vehicle, including the heating ventilation and air conditioning system (“HVAC system”), that consume electric power. An HVAC system that is compatible with an internal combustion engine may consume as many as 9 kilowatts of power during extreme conditions such as those experienced during vehicle startup when temperatures may range from a low of −40° C. and a high of 85° C. Such an HVAC system may consume as much as 4.5 kilowatts when operating at a steady state i.e. when it is operating at an output level necessary to maintain a predetermined temperature rather than changing the temperature. While such an HVAC system may have no appreciable impact on the gas mileage or the range of an internal combustion engine. If that same HVAC system were installed in a hybrid electric vehicle, a dual mode hybrid electric vehicle, or an electric vehicle, it may reduce the range of that vehicle to an unacceptably small distance.

Installing a de-powered HVAC system which consumes substantially less power, (e.g. ⅓ or ⅔ less power), may avoid an unacceptable diminution in the range of an electric or hybrid vehicle, but may lack the capacity to provide a comfortable climate within the vehicle or may require an unacceptably lengthy period of time to achieve the desired climate.

In addition to an HVAC system, other systems or subsystems are available that are capable of effecting the temperature perceived by an occupant of the vehicle. Such systems may consume far less power than the HVAC system while causing an appreciable perceived cooling or heating effect on a vehicle occupant. While such systems may be insufficient by themselves to keep a vehicle occupant comfortable, when used in conjunction with a de-powered HVAC system, the combination of these systems can be sufficient to keep the vehicle occupant comfortable.

These additional systems are typically binary in their power consumption—they are either on or off and consume a predetermined number of watts. It is desirable to use these systems in conjunction with an HVAC system and/or with a de-powered HVAC system to achieve a perceived specified temperature level within a vehicle while minimizing the combined total power consumed by all such systems. Embodiments of the present invention address these and other problems.

### SUMMARY OF THE INVENTION

Embodiments of a climate control system for an electric vehicle are disclosed herein. In a first embodiment, the climate control system includes an HVAC system adapted for installation in an electric vehicle. The HVAC system is configured to add conditioned air into a passenger compartment of an electric vehicle. The HVAC system is operable at a plurality of different power consumption states. The HVAC system is configured to transmit a signal indicative of its power consumption state. The climate control system further comprises a climate modification subsystem that is adapted for installation in the vehicle. The subsystem is configured to alter the perceived temperature of an electric vehicle occupant. The subsystem is operable at a plurality of different power consumption states. The subsystem is configured to transmit a signal indicative of its power consumption state. The first embodiment further includes a controller that is connected to the HVAC system and to the subsystem. The controller is configured to monitor the signals transmitted by the HVAC system and the subsystem. The controller is further configured to control the power consumption state of the HVAC system and the power consumption state of the subsystem. The controller is further configured to apportion power between the HVAC system and the subsystem to achieve a minimum combined power consumption state while maintaining a predetermined occupant perceived temperature.

In one implementation of the first embodiment, the HVAC system has a maximum power consumption of approximately 3,000 watts.

In another implementation of the first embodiment, a controller is configured to reapportion power between the HVAC system and the subsystem in response to a user initiated changes in the power consumption state of the HVAC and the subsystem.

In another implementation of the first embodiment, the controller is configured to monitor signals that are indicative of a temperature of a passenger compartment of the vehicle. The controller is further configured to reapportion power between the HVAC system and the subsystem in response to a temperature change detected within the passenger compartment.

In another implementation of the first embodiment, the climate controlling system further comprises a plurality of the subsystems. The controller is connected to each of the subsystems. The controller is configured to monitor signals transmitted by each of the subsystems indicative of a power consumption state of each subsystem. The controller is configured to apportion power between the HVAC system and each of the subsystems to achieve a minimum combined power consumption state while maintaining a predetermined occupant perceived temperature.

In a variation of the preceding implementation, the controller may be configured to shut down one of the subsystems to achieve the minimum combined power consumption state while maintaining the predetermined occupant perceived temperature. In another variation, one of the subsystems comprises a heat mat. In another variation, one of the subsystems comprises an air scarf. In another variation, one of the subsystems comprises a thermoelectric device. The thermoelectric device may be configured to both heat and cool an area inside the vehicle.

In a second embodiment, the climate control system includes an HVAC system that is adapted for installation in an electric vehicle. The HVAC system is configured to add conditioned air into a passenger compartment of an electric vehicle. The HVAC system is operable at a plurality of different power consumption states. The HVAC system is configured to transmit a signal indicative of its current power consumption state. The second embodiment further includes a vehicle seat assembly adapted for installation in the vehicle. The seat assembly has a climate modification subsystem. The subsystem is configured to alter the perceived temperature of a seat assembly occupant. The subsystem is operable at a plurality of different power consumption states. The subsystem is configured to transmit a signal indicative of its power consumption state. The second embodiment further includes a controller that is connected to the HVAC system and to the subsystem. The controller is configured to monitor the signals transmitted by the HVAC system and the subsystem. The controller is further configured to control the power consumption state of the HVAC system and the power consumption state of the subsystem. The controller is configured to apportion power between the HVAC system and the subsystem to achieve a minimum combined power consumption state while maintaining a predetermined occupant perceived temperature.

In one implementation of the second embodiment, the vehicle seat assembly includes an occupant detection system. The subsystem is configured to activate only when the occupant detection system detects the presence of an occupant.

In another implementation, the controller is configured to reapportion power between the HVAC system and the subsystem in response to user initiated changes in the power consumption state of the HVAC and subsystem.

In another implementation, the controller is configured to monitor signals indicative of a temperature of a passenger compartment of an electric vehicle. The controller is further configured to reapportion power between the HVAC system and the subsystem in response to temperature changes detected within the passenger compartment.

In another implementation, the vehicle seat assembly further includes a plurality of the subsystems. The controller is connected to each of the subsystems. The controller is configured to monitor signals transmitted by each of the subsystems that are indicative of a power consumption state of each subsystem. The controller is configured to apportion power between the HVAC system and each of the subsystems to achieve a minimum combined power consumption state while maintaining a predetermined occupant perceived temperature.

In a variation of the preceding implementation, one of the subsystems comprises a heat mat. In another variation, one of the subsystems comprises an air scarf. In another variation, one of the subsystems comprises a thermoelectric device. In another variation, one of the subsystems comprises an air scarf, one of the subsystems comprises a heat mat, and one of the subsystems comprises a thermal electric device.

In a third embodiment, the climate control system includes an HVAC system that is adapted for installation in an electric vehicle. The HVAC system is configured to add conditioned air into a passenger compartment of an electric vehicle. The HVAC system is operable at a plurality of different power consumption states. The HVAC system includes a first controller configured to control the power consumption state of the HVAC system. The HVAC system is configured to transmit a signal that is indicative of the power consumption state of the HVAC system. The third embodiment further includes a climate modification subsystem that is adapted for installation in the vehicle. The subsystem is configured to alter the perceived temperature of an electric vehicle occupant. The subsystem is operable at a plurality of different power consumption states. The subsystem includes a second controller that is configured to control the power consumption state of the subsystem. The subsystem is configured to transmit a signal that is indicative of the power consumption state of the subsystem. In this third embodiment, the first controller is configured to receive the signal transmitted by the subsystem, the second controller is configured to receive the signal transmitted by the HVAC system, and the first controller and the second controller cooperate to set the respective power consumption states of the HVAC system and the subsystem to achieve a minimum combined power consumption state while maintaining a predetermined occupant perceived temperature.

### BRIEF DESCRIPTION OF THE DRAWINGS

The description herein makes reference to the accompanying drawings wherein like reference numerals refer to like parts throughout the several views, and in which:

FIG. 1 is a block diagram illustrating an embodiment of a climate controlling system;

FIG. 2 is a block diagram illustrating an alternate embodiment of the climate controlling system illustrated in FIG. 1; and

FIG. 3 is a table showing an example of the logic employed by various components compatible with the climate controlling system depicted in FIGS. 1 and 2.

### DETAILED DESCRIPTION OF THE PREFERRED EMBODIMENT(S)

Detailed embodiments of the present invention are disclosed herein; however, it is to be understood that the disclosed embodiments are merely exemplary of the invention that may be embodied in various and alternative forms. The figures are not necessarily drawn to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

Conventional HVAC systems are frequently called upon to make the passenger compartment of a vehicle, such as an automobile, comfortable after lengthy periods of inactivity. Depending on the season, the vehicle may have been sitting for hours or days in extreme temperatures ranging from as low as −40° C. and as high as 85° C. It is not only a goal of automobile manufacturers to change the temperature inside the passenger compartment of an electric vehicle from an extreme temperature to a comfortable temperature, but also to do so in a relatively short period of time, typically between 2 to 5 minutes.

To attain a comfortable environment in a timely manner in a vehicle powered by an internal combustion engine, HVAC systems are used which consume large amounts of electrical power. For instance, when cooling or heating the passenger compartment of an electric vehicle from a high of 85° or a low of −40° C., a conventional HVAC system may consume as many as 9 kilowatts of electrical power. This will be referred to herein as an “extreme state” of operation. When the temperature inside the passenger compartment reaches the desired temperature, the conventional HVAC system may work at a reduced rate of power consumption because the HVAC system need only maintain that temperature, typically within a range of plus or minus 1½° C. The maintenance of the temperature of the passenger compartment at the desired temperature will be referred to herein as the “steady-state” operation of the HVAC system. During steady-state operation, the power consumption of a conventional HVAC system may drop to as much as one half of the power consumed when the HVAC system is operating at an extreme state. For example, some conventional HVAC systems will require 4.5 kilowatts of energy when operating at steady-state.

When managing the electric power consumed by a conventional vehicle having an internal combustion engine, the impact of power consumption by components such as the HVAC system do not typically have a significant impact on the range that such a vehicle can travel on a given amount of fuel. Accordingly, for conventional vehicles, there is no significant range related barriers to the use of increasingly powerful HVAC systems.

In the case of electric vehicles and hybrid electric vehicles which generate and transmit torque to drive wheels either partially or entirely through the conversion of electric energy into torque, the electric power consumption of non-torque generating systems and components within the electric vehicle can have a significant impact on such an electric vehicle's range. For avoidance of confusion, when the term “electric vehicle” is used hereinafter, that reference is intended to refer to either an electric vehicle or a hybrid electric vehicle and variations thereof unless specifically stated otherwise. The use of a conventional HVAC system (i.e. one that consumes 9 kilowatts of electric power when operating at an extreme state) may constitute an unacceptable drain on the electric vehicle's battery or may otherwise consume an unacceptable level of electric energy such that the range of the electric vehicle would be rendered unacceptably low. It is therefore desirable to use a significantly de-powered or reduced power HVAC system in an electric vehicle. Such a de-powered HVAC system may consume as little as 1/3 the power consumed by a conventional HVAC system both when operating at an extreme state or when operating at a steady-state.

While such a de-powered HVAC system may not unacceptably reduce the electric vehicle's range, the de-powered HVAC system may not, by itself, be adequate to reach steady-state operations within a period of time deemed acceptable to the vehicle occupants. The climate controlling system disclosed herein incorporates additional subsystems which are configured to effect the temperature perceived by an occupant of the electric vehicle and tie them together with the HVAC system using a controller that reads the operational condition or state of the HVAC system and the operational condition or power consumption state of each climate modification subsystem to determine an optimal operational state or power consumption condition of each system or subsystem to achieve a perceived temperature while simultaneously minimizing the total power consumed by the HVAC system and each climate modification subsystem. As used herein, the term “perceived temperature” refers to the physical effect of exposure to a localized application of increased or decreased temperature on the body of a vehicle occupant. For example, a person exposed to a temperature of 30° F. may feel the sensation of temperatures far lower than 30° F. in the presence of wind (i.e. wind chill). The same physiological effect is employed by the climate controlling system disclosed herein to allow an electric vehicle occupant to “perceive” that their body is at the desired temperature while the passenger compartment of the vehicle is in fact much hotter or much cooler. Some controllers may incorporate a fuzzy logic algorithm to apportion power between the HVAC system and the various climate modification subsystems in an attempt to maintain the vehicle occupant's perception of the desired temperature while simultaneously maximizing electric vehicle range through minimization of the combined total consumption of electric power by the HVAC system and all climate modification subsystems. In some embodiments, the climate control system may control and apportion electric power to the various climate modification subsystems to maintain a “perceived” occupant temperature while the HVAC system operates at a steady-state and in other embodiments, such apportionment of electric power may occur only during HVAC system operation at an extreme state. Understanding of the invention disclosed herein may be enhanced by reference to the figures included herewith and described below.

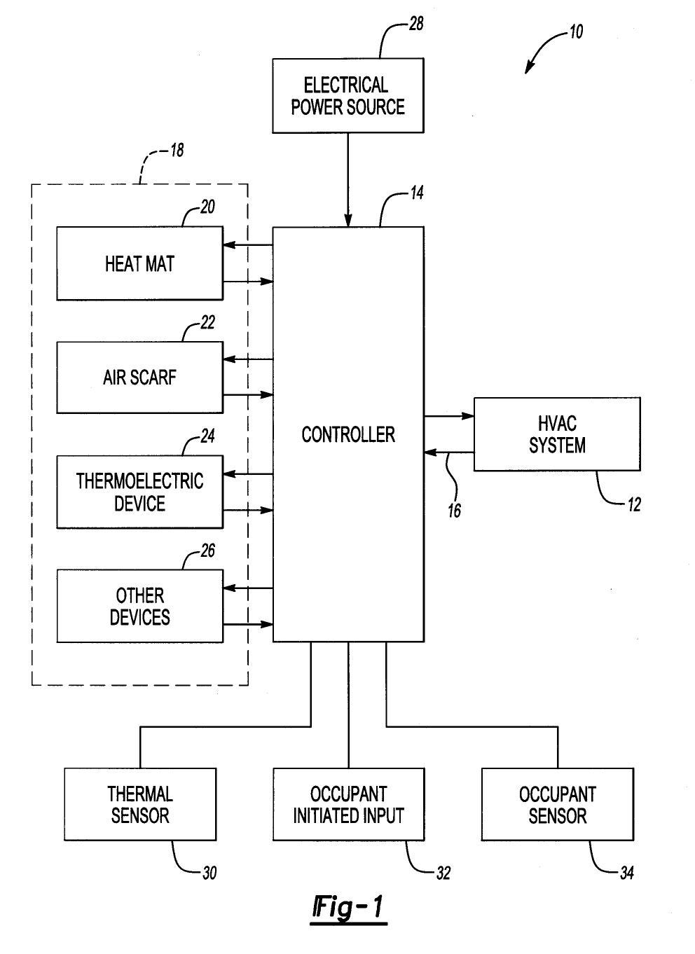

With reference to FIG. 1, a block diagram illustrating an embodiment of a climate controlling system 10 made in accordance with the teachings of the present invention is illustrated. The climate controlling system 10 includes an HVAC system 12 adapted for installation into an electric vehicle and capable of moving heated or cooled air into a passenger compartment of the vehicle. In some embodiments, HVAC system 12 may be configured to consume no more than approximately 3 kilowatts of electric power. HVAC system 12 is connected to controller 14. HVAC system 12 is configured to transmit a power consumption state of HVAC system 12 to controller 14 at periodic intervals. In some embodiments, the power consumption signal transmitted by HVAC system may be indicative of extreme operation, steady-state operation, whether a compressor or a heater coil is operational or whether HVAC system 12 is merely operating as a vent to move unheated or uncooled air into the passenger compartment. Controller 14 may take any suitable form including any computer or microprocessor configured to implement algorithms.

A plurality of climate modification subsystems 18 are also connected to controller 14. Climate modification subsystems 18 include devices which are capable of altering the perception of an occupant of the vehicle's passenger compartment regarding the temperature of his or her environment. Three specific examples of climate modification subsystems are identified in FIG. 1. These include a heat mat 20, an air scarf 22 and a thermoelectric device 24. Other devices 26 are referred to generally to indicate that the list of available and compatible climate modification subsystems is not limited to heat mat 20, air scarf 22, and thermoelectric device 24. Other devices may include systems which raise and lower vehicle windows and systems which turn on and off an exhaust fan or fans which direct air to and from ancillary ventilation ducts.

Heat mat 20 was disclosed in pending patent application Ser. No. 11/821,984 which is hereby incorporated herein in its entirety. In general terms, the heat mat may include a mat having a plurality of coils positioned on a seat portion of an electric vehicle seat and a mat including a plurality of heatable coils positioned on a backrest portion of an electric vehicle seat. When activated, rather than heating all of the coils of both mats of heat mat 20, individual coils may be activated one at a time to allow a more rapid heating of that individual coil then would otherwise occur if the electric power were apportioned to all of the coils in the mat at once. Sequential activation of individual coils allow those individual coils to achieve their maximum temperature quite quickly thus creating the impression on the part of the seat occupant of rapid, substantial heating. As the coils achieve their maximum design temperature, electric power may be apportioned to other coils in each of the mats. Those coils will also rapidly heat because they are not sharing electric power with the coils that were initially heated. This further enhances the perception on the part of a seat occupant of escalating and pervasive warmth.

Air scarf 22 may include a seat contained ventilation system capable of heating and cooling air mounted in the backrest portion of a vehicle seat. Air scarf 22 further includes a series of ducts routed throughout an electric vehicle seat that are configured to direct heated or cooled air into area disposed along an upper portion of the seat back. This has the effect of blowing heated or cooled air on the back of the neck of vehicle seat occupant. This contributes to the vehicle occupant's perception of a desired temperature. Embodiments of air scarf 22 are disclosed in U.S. Pat. Nos. 6,786,545; 6,761,399; 6,746,076; and 6,644,735 and in the pending U.S. patent application having the Publication No. 2006/0267383, the disclosures of which are hereby incorporated herein in their entirety.

Thermoelectric devices are well-known in the industry and are capable of using electric power to heat or cool air flowing past such thermoelectric devices. An electric vehicle seat may be equipped with a thermoelectric device 24 and may include appropriate ducting located throughout a seat portion and a backrest portion of an electric vehicle seat to direct heated or cooled air directly onto the body of the seat occupant. As with the wind chill phenomenon discussed above, such direct venting of heated and cooled air has an impact on the seat occupant's perception of the temperature that they are experiencing. Other devices 26 may include devices not incorporated into the vehicle seat, but rather, incorporated into other portions of the passenger compartment of the vehicle proximate a seat occupant to direct heated and/or cooled air onto the occupant. Such devices may easily be incorporated into pillars, headliners, and floors of an electric vehicle proximate an electric vehicle seat to allow a seat occupant to perceive a desired temperature.

HVAC system 12, heat mat 20, air scarf 22, and thermoelectric device 24, as well as other devices 26 may operate within a known range of power consumption. Each of these systems/subsystems will have a maximum and a minimum power consumption. Each climate modification subsystem 18 is configured to transmit a signal to controller 14 indicative of the power consumption state of that particular climate modification subsystem 18. Controller 14 receives electrical power from electrical power source 28 and apportions that electric power between HVAC system 12 and the various climate modification subsystems 18. Power source 28 may comprise a vehicle battery, a battery associated with the hybrid electric powertrain, regenerative braking, solar panels, to name a few. In some embodiments, controller 14 may have a baseline temperature target (e.g. 72° F.) at which a majority of the population will be comfortable. Controller 14 will receive the power consumption state signal from each individual climate modification subsystem 18 and will apportion the electric power supplied by electric power source 28 between HVAC system 12 and climate modification subsystems 18, taking into account known effects of the heating and cooling activities of each individual climate modification subsystem 18 on a human body to achieve the perceived baseline temperature while minimizing the combined total power consumption consumed by HVAC system 12 and each climate modification subsystem 18 as HVAC system 12.

For example, in an electric vehicle having a passenger compartment at a temperature of 85° C. at the time when the electric vehicle is started the controller 14 may calculate that operation of HVAC system 12 at its maximum power consumption together with operation of air scarf 22 and thermoelectric device 24 at their respective maximum power consumption while keeping heat mat 20 in an inactivated state is the most efficient and immediate way to create a perceived baseline temperature of 37° C. as HVAC system 12 works to lower the temperature of the passenger compartment to a temperature of 37° C. Climate controlling system 10 includes a thermal sensor 30 disposed in the passenger compartment and configured to detect the ambient temperature within the passenger compartment. As thermal sensor 30 detects a cooling of the air inside the passenger compartment, thermal sensor 30 sends a signal to controller 14 indicative of the temperature within the passenger compartment. Controller 14 may then reduce the power directed to air scarf 22 and/or thermoelectric device 24 to reduce overall power consumption. This is possible because as the passenger compartment cools, the contribution required of the climate modification subsystems 18 is reduced.

As the temperature within the passenger compartment reaches the baseline temperature of 37° C., controller 14 may reduce the power apportioned to HVAC system 12 to send it into steady-state operation. Similarly, controller 14 may reduce the power apportioned to air scarf 22 and thermoelectric device 24 or possibly turn those devices off entirely. Alternatively, controller 14 may reduce the power to HVAC system 12 below that power setting associated with steady-state operation and increase power to air scarf 22 and thermoelectric device 24 to continue relying on the principals of perceived cooling to maintain the comfort of the vehicle occupant. One goal of the algorithm applied by controller 14 is to minimize aggregate power consumption by HVAC system 12 and climate modification subsystems 18 while providing a vehicle occupant with a comfortable environment wherein the occupant perceives the temperature to be a desired temperature when it is not. This maximizes the comfort of an electric vehicle occupant while simultaneously maximizing the range of the electric vehicle.

Controller 14 is also configured to accommodate occupant initiated inputs 32 such as when an electric vehicle occupant increases or reduces the baseline temperature. For instance, if an electric vehicle occupant requests that the passenger compartment be set to a temperature of 33° C., controller 14 will apportion electrical power between HVAC system 12 and climate modification subsystems 18 in a manner that rapidly achieves and maintains the perceived temperature of 33° C. while minimizing the total electrical power consumed by HVAC system 12 and the various climate modification subsystems 18.

The use of multiple climate modification subsystems 18 together with HVAC system 12 can more efficiently achieve a desired perceived temperature than a higher powered HVAC system. This is because an HVAC system attempts to heat or cool the air throughout the entire passenger compartment whereas use of the climate modification subsystems 18 need only condition the air in an area immediately adjacent the occupant of the electric vehicle. This reduces the electric power required to achieve the desired effect. In some embodiments of climate controlling system 10, an occupant sensor 34 may be included to detect the presence of an occupant in each seat within the vehicle. Occupant sensor 34 may take any form including a detector capable of detecting when a seatbelt is latched, a weight detector capable of detecting the presence of objects in a seat, an infrared sensor, and a sonar device, to name a few. If occupant sensor 34 detects that an electric vehicle seat is unoccupied, then the climate modification subsystems 18 associated with that vehicle seat will not be activated, thus further reducing the amount of electrical power consumed as the vehicle occupant is heated or cooled to the baseline or other desirable perceived temperature.

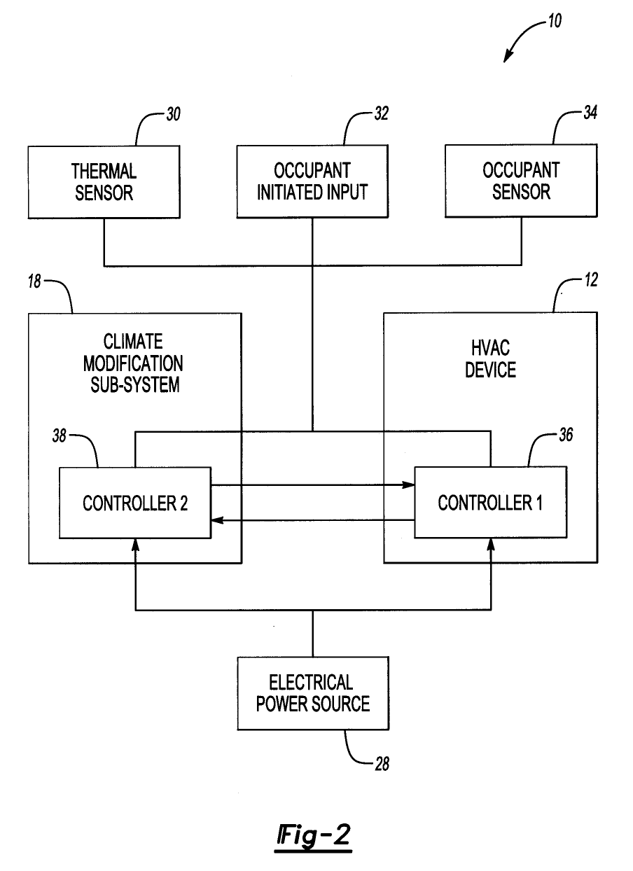

With respect to FIG. 2, a block diagram is presented illustrating an alternate embodiment of climate controlling system 10. In the embodiment depicted in FIG. 2, rather than having a central controller 14 that communicates with each climate modification subsystem 18 and the HVAC system 12, each climate modification subsystem 18 and HVAC system 12 includes its own controller. For instance, HVAC system 12 has a first controller 36 and climate modification subsystem 18 has a second controller 38. Controllers 36 and 38 each include an algorithm that permits the maintenance of a perceived baseline or a user determined temperature while minimizing the aggregate power consumed by HVAC system 12 and climate modification subsystem 18. First and second controllers 36 and 38 each receive signals from thermal sensor 30, occupant initiated inputs 32, occupant sensors 34. Additionally, first controller 36 receives a signal from second controller 38 indicative of an electric power consumption state of climate modification subsystem 18. Second controller 38 receives a signal from first controller 36 indicative of an electric power consumption state of HVAC device 12. First and second controllers 36 and 38 are configured to implement their respective programmed algorithms to determine a minimum aggregate power consumption by HVAC system 12 and climate modification subsystem 18. First and second controllers 36 and 38 are each configured to implement their respective algorithms to determine an appropriate power consumption state for itself and to set its own respective system/subsystem to that desired power consumption state.

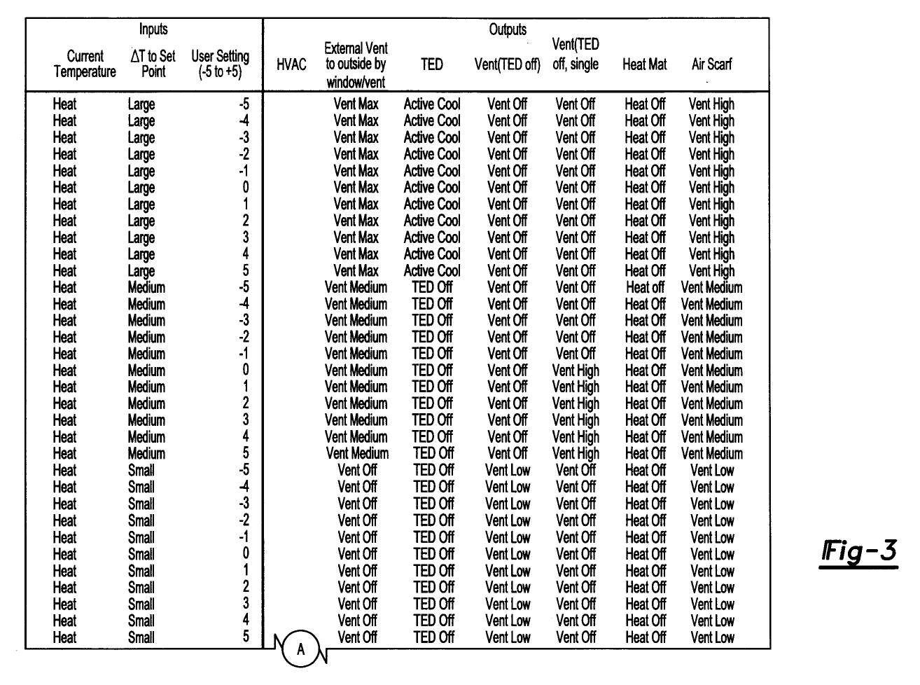

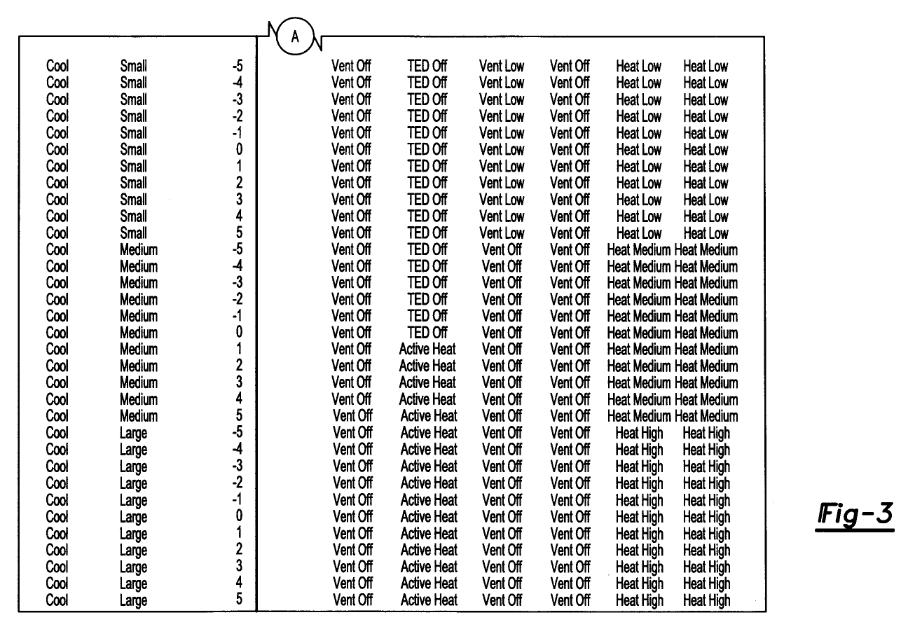

FIG. 3 is a table illustrating various initial conditions upon activation of climate controlling system 10 and operational settings for various climate modification subsystems 18 including heat mat 20, air scarf 22 and thermoelectric device 24.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A climate control system for an electric vehicle, the climate control system comprising:
an HVAC system adapted for installation in an electric vehicle, the HVAC system being configured to add conditioned air into a passenger compartment of an electric vehicle, the HVAC system being operable at a plurality of different power consumption states and the HVAC system being configured to transmit a signal indicative of its power consumption state;
a climate modification sub-system adapted for installation in the vehicle, the sub-system being configured to alter the perceived temperature of an electric vehicle occupant, the sub-system being operable at a plurality of different power consumption states, and the sub-system being configured to transmit a signal indicative of its power consumption state; and
a controller connected to the HVAC system and to the sub-system, the controller being configured to monitor the signals transmitted by the HVAC system and the sub-system, the controller being further configured to control the power consumption state of the HVAC system and the power consumption state of the sub-system, and the controller being configured to apportion power between the HVAC system and the sub-system to achieve a minimum combined power consumption state while maintaining a predetermined occupant perceived temperature.

2. The climate controlling system of claim 1 wherein the HVAC system has a maximum power consumption of approximately 3000 Watts.

3. The climate controlling system of claim 1 wherein the controller is configured to re-apportion power between the HVAC system and the sub-system in response to a user initiated change in the power consumption state of the HVAC and the sub-system.

4. The climate controlling system of claim 1 wherein the controller is configured to monitor signals indicative of a temperature of a passenger compartment of the vehicle and wherein the controller is further configured to re-apportion power between the HVAC system and the sub-system in response to a temperature change detected within the passenger compartment.

5. The climate controlling system of claim 1 further comprising a plurality of the sub-systems, wherein the controller is connected to each of the sub-systems, the controller is configured to monitor signals transmitted by each of the sub-systems indicative of a power consumption state of each sub-system, and the controller is configured to apportion power between the HVAC system and each of the sub-systems to achieve a minimum combined power consumption state while maintaining a predetermined occupant perceived temperature.

6. The climate controlling system of claim 5 wherein the controller is configured to shut down one of the sub-systems to achieve the minimum combined power consumption state while maintaining the predetermined occupant perceived temperature.

7. The climate controlling system of claim 5 wherein one of the subsystems comprises a heat mat.

8. The climate controlling system of claim 5 wherein one of the sub-systems comprises an air scarf.

9. The climate controlling system of claim 5 wherein one of the sub-systems comprises a Thermoelectric device.

10. The climate controlling system of claim 9 wherein the thermoelectric device is configured to heat and cool an area inside the vehicle.

11. A climate controlling system for an electric vehicle, the climate controlling system comprising:
an HVAC system adapted for installation in an electric vehicle, the HVAC system being configured to add conditioned air into a passenger compartment of an electric vehicle, the HVAC system being operable at a plurality of different power consumption states and the HVAC system being configured to transmit a signal indicative of its current power consumption state;
an electric vehicle seat assembly adapted for installation in the vehicle, the vehicle seat assembly having a climate modification sub-system, the sub-system being configured to alter the perceived temperature of the vehicle seat occupant, the sub-system being operable at a plurality of different power consumption states, and the sub-system being configured to transmit a signal indicative of its power consumption state; and
a controller connected to the HVAC system and to the sub-system, the controller being configured to monitor the signals transmitted by the HVAC system and the sub-system, the controller being further configured to control the power consumption state of the HVAC system and the power consumption state of the sub-system, and the controller being configured to apportion power between the HVAC system and the sub-system to achieve a minimum combined power consumption state while maintaining a predetermined occupant perceived temperature.

12. The climate controlling system of claim 11 wherein the vehicle seat assembly includes an occupant detection system and wherein the sub-system is configured to activate only when the occupant detection system detects the presence of an occupant.

13. The climate controlling system of claim 11 wherein the controller is configured to re-apportion power between the HVAC system and the sub-system in response to a user initiated change in the power consumption state of the HVAC and sub-system.

14. The climate controlling system of claim 11 wherein the controller is configured to monitor signals indicative of a temperature of a passenger compartment of the vehicle and wherein the controller is further configured to re-apportion power between the HVAC system and the sub-system in response to a temperature change detected within the passenger compartment.

15. The climate controlling system of claim 11 wherein the vehicle seat assembly further comprises a plurality of the sub-systems, wherein the controller is connected to each of the sub-systems, the controller is configured to monitor signals transmitted by each of the sub-systems indicative of a power consumption state of each sub-system, and the controller is configured to apportion power between the HVAC system and each of the sub-systems to achieve a minimum combined power consumption state while maintaining a predetermined occupant perceived temperature.

16. The climate controlling system of claim 15 wherein one of the subsystems comprises a heat mat.

17. The climate controlling system of claim 15 wherein one of the sub-systems comprises an air scarf.

18. The climate controlling system of claim 15 wherein one of the sub-systems comprises a Thermoelectric device.

19. The climate controlling system of claim 18 wherein one of the sub-systems comprises an air scarf and one of the sub-systems comprises a heat mat.

20. A climate controlling system for an electric vehicle, the climate controlling system comprising:
an HVAC system adapted for installation in an electric vehicle, the HVAC system being configured to add conditioned air into a passenger compartment of an electric vehicle, the HVAC system being operable at a plurality of different power consumption states, the HVAC system including a first controller configured to control the power consumption state of the HVAC system, and the HVAC system configured to transmit a signal indicative of the power consumption state of the HVAC system; and
a climate modification sub-system adapted for installation in the vehicle, the sub-system being configured to alter the perceived temperature of an electric occupant, the sub-system being operable at a plurality of different power consumption states, the sub-system including a second controller configured to control the power consumption state of the sub-system, and the sub-system configured to transmit a signal indicative of the power consumption state of the sub-system,
wherein the first controller is configured to receive the signal transmitted by the sub system, wherein the second controller is configured to receive the signal transmitted by the HVAC system, and wherein the first controller and the second controller cooperate to set the respective power consumption states of the HVAC system and the sub-system to achieve a minimum combined power consumption state while maintaining a predetermined occupant perceived temperature.
